(19) United States
(12) Patent Application Publication
(10) Pub. No.: US 2025/0322644 A1
(43) Pub. Date: Oct. 16, 2025

(54) Method for Temporal Detection of Actions

(71) Applicant: Robert Bosch GmbH, Stuttgart (DE)

(72) Inventors: Chun Yang, Budapest (HU); Attila Bodnar, Mosonmagyarovar (HU)

(21) Appl. No.: 19/175,349

(22) Filed: Apr. 10, 2025

(30) Foreign Application Priority Data
Apr. 15, 2024 (DE) 10 2024 203 435.5

(51) Int. Cl. G06V 10/764; G06V 10/62; G06V 10/82; G06V 20/56

(52) U.S. Cl. CPC G06V 10/764; G06V 10/62; G06V 10/82; G06V 20/56

(57) ABSTRACT

A method for the temporal detection of actions, and an associated computer program, storage medium and data processing device is disclosed.

This application claims priority under 35 U.S.C. § 119 to application no. DE 10 2024 203 435.5, filed on Apr. 15, 2024 in Germany, the disclosure of which is incorporated herein by reference in its entirety.

The disclosure relates to a method for temporal detection of actions. The disclosure further relates to a computer program, a device, and a storage medium for this purpose.

### BACKGROUND

Methods for action recognition in videos and images are known in the prior art. It is also known to perform temporal action detection (TAD).

The former deals with cut videos, meaning that a video or clip contains no more than one category of actions (see [15], wherein the references are provided at the end of the description).

The second method deals with uncut videos that can represent many different types of actions in a clip. In addition to the classification, the start and end time of each recognized action instance can also be estimated. However, this is often a major challenge, as the number of actions, their categories and their temporal location are unknown.

The prior art shows that TAD is typically associated with more complex neural network architectures. The architecture of a TAD network can be divided into three basic types according to the phase in which the temporal information is acquired: Firstly, in the input phase, e.g. using two data streams, i.e. RGB and optical flow, as input (see [4] and [6]). In so doing, the optical flow may be used to acquire movement information between the images. The second type of temporal information acquisition is associated with feature extraction n a backbone, such as the use of 3D CNN structures (see [2], [3], [5], and [12]). The third type is in the neck/head stage of the network and is often implemented by a 1D temporal CNN (see [1] and [2]). Based on the three basic types mentioned above, there are also hybrid types formed by different combinations of the basic types.

With regard to the way in which the temporal information on the action can ultimately be obtained, there are two main possibilities: Unit level classification often uses a regressor in order to regress the start and end time (see [1], [2], [4], [7] and [9]). For frame level classification, fusing or smoothing is often done in order to form the start and end times of action instances (see and [11]).

In order to achieve better performance in the TAD, conventional methods typically use a complex framework, e.g. two streams as input, 3D CNN or two independent networks (cf. [9]). Alternatively, a regressor is used to retrieve the time information. These approaches increase the size of the framework, the processing time of the pipeline, and the sensitivity of the network to the setting of the parameters and training strategy.

### SUMMARY

The subject-matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that a reciprocal reference is always possible with regard to the disclosure of the disclosure.

The object of the disclosure is in particular a method for the temporal detection of actions. The following steps of the method may be performed in an automated manner, and/or repeatedly, and/or sequentially.

The method according to the disclosure may comprise, as a first step, a provision of image data. For this purpose, the image data may be received, for example, as digital image data from a sensor device. The image data may represent a temporal sequence of actions. The image data can result from sensory acquisition, preferably by a sensor device, and in particular at least one sensor of a vehicle. Furthermore, a time axis can be defined in the image data by the temporal sequence. In particular, this should be understood to mean that the image data is available in a particular order that makes it possible to trace the temporal sequence of the actions along the time axis. As a result, for example, movement sequences of vehicles or persons can be acquired and classified.

As a further step, the method according to the disclosure can comprise defining a plurality of time points along the time axis. This can be understood to mean that several time points may be predetermined, which lie along the time axis, in particular at fixed or irregular distances to each other. A plurality of consecutive time points may define a temporal area accordingly. A plurality of different ones of the areas may form so-called candidate areas in which actions of certain classes are suspected.

As a further step, the method according to the disclosure may comprise processing the provided image data through a plurality of windowings along the time axis. For this purpose, a plurality of windows of different length can be aligned with their respective window anchors at each of the defined time points. This may (also) serve to define a temporal area of the image data along the time axis, in which the windowing is to take place, in particular. The window anchor may be provided for each window as a certain/normalized position of the window. In other words, the window anchors may be defined by a predefined position along the windows. This allows for more precise windowing of the image data in the temporal area of the windows and window anchors in each case, thereby providing processed (windowed) image data for each window anchor. A plurality of windows of different length can be used for each time point, and corresponding processed (windowed) image data can be obtained for the different sized temporal areas defined in each case.

As a further step, the method according to the disclosure may comprise determining confidence scores for each of the window anchors or each of the windows. For this purpose, the represented actions can be classified on the basis of the processed image data in the temporal area defined in each case. In other words, this classification may be used to determine the confidence scores for each of the window anchors, which in particular indicate the probability that the desired action (according to a corresponding class) is actually represented on the window anchors. Accordingly, as many different confidence scores may be determined per window anchor as predetermined classes. In other words, confidence scores may be determined for each window anchor N, where N may correspond to the number of classes used for classification.

As a further step, the method according to the disclosure may comprise performing, in particular automated, evaluations for the window anchors. The evaluations may be made specifically for those window anchors that are aligned to the same time point. For this purpose, an average calculation of the confidence scores determined for the window anchors aligned at the same time point may be made.

The method according to the disclosure may comprise as a further step providing one or more temporal candidate areas for the defined time points and/or based on the evaluations in each case as a candidate for detection of at least one of the actions.

The method according to the disclosure may comprise as a further step determining one or more regional confidence scores for the respective candidate area. For this purpose, the determined confidence scores for those window anchors that are aligned at a time point in (within) the respective candidate area(s) can be processed. The regional confidence score may also be referred to as a regional trust score. In particular, the processing may include a calculation of an average and/or a deviation of the confidence scores for the window anchors/windows in the entire candidate area. This has the advantage that the suitability and/or quality of the processed/windowed image data in the candidate area can be evaluated more precisely for action detection and, in particular, classification. As a result, window anchors/windows suitable for the action recognition, and in particular temporal areas, can be selected more quickly and efficiently for action detection.

The method according to the disclosure can comprise performing the detection as a further step. This may comprise a classification the at least one action in at least one of the candidate areas based on the regional confidence scores and determining, preferably estimating, a time allocation, in particular a start and end time, of the respective classified action. The time allocation may preferably be determined according to determined winning classes. This means that a result of the classification, in particular winning classes in terms of groupings of predictions having similar features, can be used to determine the time allocation.

This has the advantage that the actions may be reliably detected in terms of their duration and their temporal occurrence.

The provided image data may be configured as video. In particular, the video is at least partially an uncut video depicting a plurality of different types of actions in a clip.

Detection of the actions may include a classification of the respective action based on a plurality of predefined classes and, in addition to classification, also determining, preferably estimating, a time allocation, i.e., in particular a start and end time, of each detected action.

Furthermore, it may be provided that the alignment of the windows comprises defining the window anchors of the windows as the centers of the windows. It may further be provided that the windows of different length, which are to be aligned at the same time point, are aligned by aligning their centers with the same time point. This has the advantage that multiple windows of different length may be used for windowing at any time, in order to be able to take into account multiple temporal areas for possible action detection.

Advantageously, in the context of the disclosure, it may be provided that performing the evaluations for the window anchors aligned at the same time point comprises in each case:
forming an average value of the determined confidence scores for the window anchors in order to reduce fluctuations due to different window lengths,
comparing the average value formed with a predefined evaluation criterion, preferably a threshold value, to evaluate the window anchors. This has the advantage that a reliable evaluation of the windows for the classification is possible.

It may be advantageous if, in the context of the disclosure, providing the one or more temporal candidate areas comprises determining those window anchors that have a sufficient evaluation. The respective candidate area can then be defined based, in particular as a time interval, on successive time points along the time axis at which the window anchors are aligned with sufficient evaluation. This has the advantage that different temporal areas can be taken into account as candidates for action detection.

For example, it may be provided that classifying the at least one action comprises an application of a machine learning model, preferably a convolutional neural network (CNN), wherein the following steps may be provided to determine the at least one confidence score:
dividing the respective window into multiple segments,
randomly selecting an image from each of the segments,
processing the respective selected image by the machine learning model in order to extract at least one feature,
concatenating the extracted features,
determining the confidence score for the window anchor of the respective window based on the concatenated features.
   Here, preferably, the machine learning model is be a two-dimensional CNN having a head. This simplifies processing and enables reliable determination of confidence scores.

It may be advantageous if, in the context of the disclosure, the processing to determine the one or more regional confidence scores comprises at least one of the following processing steps: an averaging and/or a smoothing, and/or an evaluation of a deviation, respectively of or based on the determined confidence scores for those window anchors aligned at a time point in the respective candidate area. Thus, reliability in determining a possible area for action detection may be improved.

It is also advantageous if a vehicle action is recognized in an environment of a vehicle based on the detection and in particular the classification and/or the time allocation, preferably for at least partially automated driving. In so doing, the image data may result from sensory acquisition of the environment while driving a vehicle.

The classification may preferably be performed as an image classification based on data points—e.g. pixels and preferably pixel values—of the image data. A machine learning model (ML model) may be used for this purpose, which has previously been trained for classification and/or action detection. The use, and with it the inference of the ML model, can be provided in a vehicle, for example. The data points can be pixels of image data or be based on these in order to carry out the classification and/or object detection of the data points on the basis of the pixels. Specifically, it can be provided that the surroundings of a sensor and/or a vehicle and/or a traffic scene are represented by the values of image points, preferably pixels, of the image data. Classification, preferably image classification and/or action detection, based on of these values can be provided. This makes it possible to detect actions, preferably of objects, of the traffic scene, for example. The classification can also be provided in the form of semantic segmentation (i.e., pixel-by-pixel or area-by-area classification). The image data can be images of a radar sensor and/or an ultrasonic sensor and/or a LiDAR sensor and/or a thermal imaging camera for example. Accordingly, the images can also be configured as radar images and/or ultrasonic images and/or thermal images and/or lidar images.

Another object of the disclosure is a computer program, in particular a computer program product, comprising commands which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 For each window anchor or for each candidate region, N confidence scores may be determined, wherein N may correspond to the number of classes used for classification.

FIG. 2 a schematic illustration of steps of a method according to exemplary embodiments of the disclosure.

FIG. 3 a further schematic illustration of steps of a method according to exemplary embodiments of the disclosure.

FIG. 4 a result of the method according to embodiments of the disclosure for driving scenario videos

### DETAILED DESCRIPTION

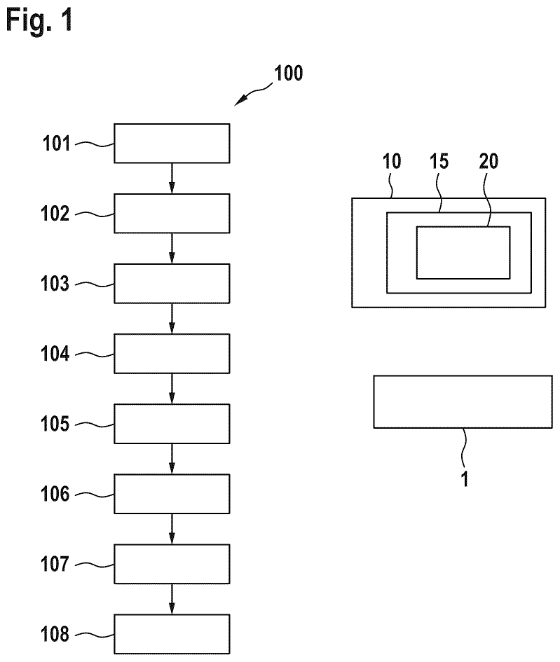

FIG. 1 schematically illustrates a method 100, a device 10, a storage medium 15, and a computer program 20 according to exemplary embodiments of the disclosure. The method 100 may serve for temporal detection of actions, preferably in connection with an operation of a vehicle 1.

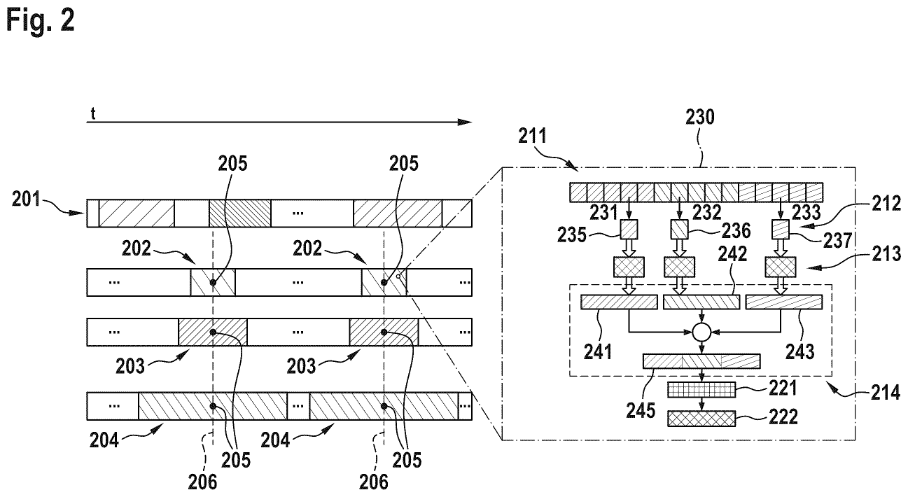

According to a first method step 101, a provision of image data 201 shown in FIG. 2 may be provided. The image data 201 may represent a temporal sequence of actions and result from sensory acquisition, preferably in the vehicle 1. A time axis t can be defined by the temporal sequence, as shown schematically in FIG. 1 by a timeline.

According to a second method step 102, defining a plurality of time points 206 along the time axis t may occur. For example, two time points 206 are labeled in FIG. 2. According to a third method step, processing of the provided image data 201 may be provided by a plurality of windowings along the time axis t. For this purpose, multiple windows 202, 203, 204 of different length can be aligned with their respective window anchors 205 at each of the defined time points 206, in order to define a temporal area of the image data 201 along the time axis t in each case. The window anchors 205 may be defined by a predefined position along the windows 202, 203, 204. In FIG. 2, it can be seen that (from top to bottom) windows of shorter temporal length 202, medium length 203, and longer length 204 are aligned at the same time points 206. The alignment takes place at the window anchor 205, which is represented by a dot. This allows a “centering” of the windows of different length at the same time points 206. The use of different lengths has the advantage that even those actions shown in the image data 201 can be covered by at least one of the windows if they are located away from the defined time points 206.

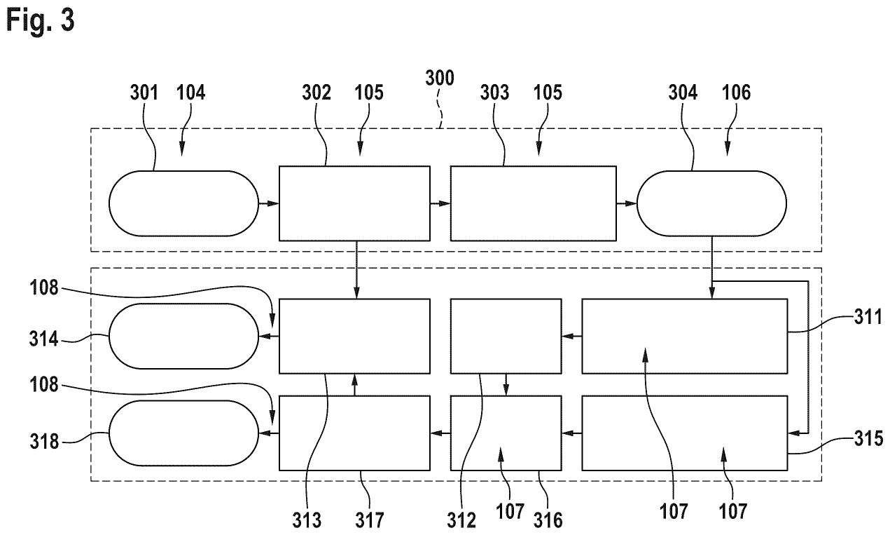

According to a fourth method step 104, a determination of confidence scores may be made, in particular depending on the number of classes for each of the window anchors 205. The represented actions can be classified on the basis of the processed image data 201 in the temporal area defined in each case. The fourth method step 104 is shown in FIG. 3 with further details. It may comprise step 301 (determining confidence scores for each window anchor with respect to all action classes).

According to a fifth method step 105, it may be possible to perform evaluations for the window anchors 205 aligned at the same time point 206. For this purpose, an averaging of the confidence scores determined for the window anchors 205 aligned at the same time point 206 may be made. In FIG. 3, this may comprise steps 302 (calculating average confidence scores of all window types at each time point) and 303 (grouping successive areas where the average confidence scores are above a threshold value over all window types).

Subsequently, according to a sixth method step 106, in particular according to step 304 in FIG. 3, one or more temporal candidate areas can be provided for the defined time points 206 and based on the evaluations in each case as a candidate for detection of at least one of the actions.

In a seventh method step 107, determining one or more regional confidence scores may be provided for the respective candidate area. For this purpose, the determined confidence scores for those window anchors 205 aligned at a time point 206 in the respective candidate area may be processed. The processing may comprise steps 311 (calculation, at each time point, of fluctuations of the confidence scores and the difference of each type of window relative to the average over all window types), 315 (average of all window anchors within the candidate area) and 316 (determining the regional confidence score), as shown in FIG. 3.

According to an eighth method step 108, the detection may be performed, which comprises a classification (see steps 317, 318 in FIG. 3) of the at least one action in at least one of the candidate areas, based on the regional confidence scores, and a determination of a time allocation (see steps 313, 314), in particular a start and end time, of the respective classified action.

In this way, the method according to exemplary embodiments of the disclosure can reliably achieve high performance for TAD-related tasks with a simple but effective solution. The model used for classification may have two parts: a pure RGB, time-window-anchor-based and a 2D-CNN-linked neural network visualized in FIG. 2 for predicting the confidence scores, followed by a regional confidence module (RCM) illustrated in FIG. 3 for determining a time allocation, in particular in the form of temporal bounding boxes, and the classification, in particular the formation of labels. Exemplary embodiments of the disclosure may further be a natural extension of the solution described in reference from the application in cropped video to that in the uncropped video.

In the real world, there are such scenarios where actions and events are fast and abrupt. In road traffic, for example, vehicles typically pull out very quickly, sometimes without any indication, such as by using turn signals. These actions are distinctly different from other normal human actions, such as housework, sports, etc.

On the one hand, in driving events such as an overtaking maneuver, there is little context that could provide clues before and after the duration of the event or from the background of the scene, so that the road user can pull out or simply stay in the same lane even if the adjacent lane is empty. This depends, for example, on the driver's habits and preferences and is therefore difficult to predict. In contrast, the preparation and follow-up of other human actions typically provide much richer information that helps to reconstruct the actual timing of events.

Thus, instead of using the two heads popular in the prior art, i.e. classifier plus regressor as output, according to embodiments of the disclosure only the classifier can be used as a single-head output. From this, the confidence scores may be obtained for each input unit, in particular with the window anchor described in more detail below. Subsequently, RCM (which is based on the statistics of the scores) may be applied to determine the temporal position and label of each action instance.

The structure described may in particular be used because there is a high correlation between the at least one confidence score of the window anchor and its tIOU (temporal intersection over union) with the ground truth. Thus, if a high confidence score is obtained, approximately greater than 0.5, there may most likely be a significant tIOU for the ground truth.

On the other hand, events of a vehicle often show movements explicitly at the pixel level, meaning that the changes in the pixels between adjacent frames are recognizable. The action recognition solution in has shown its distinguishability in the above-mentioned driving scenarios using RGB front camera input, so that it can be reused as the backbone of the TAD model according to exemplary embodiments of the disclosure and also maintain the same RGB-exclusive modality.

Based on the above-mentioned reasons and the previous work on action recognition, an RGB-only, 2D-CNN-backboneed and one-head framework is proposed according to exemplary embodiments of the disclosure. The framework has the advantage that it is possible to use simpler networks to solve the TAD problem.

In the prior art, complex frameworks and training strategies are often used to address the issue of temporal action recognition. There are already publications that show that even simple structures can achieve amazing performance in action recognition (cf. [1] and [2]). The solution according to exemplary embodiments of the disclosure demonstrates a similar view in practice. In summary, the model described has the following advantages in particular.

The proposed method and model used, preferably machine learning model, has a very simple structure and processing pipeline, which is in particular only made up of RGB, a stage, a 2D-CNN backbone and a head, which makes the training stable and converges quickly. In FIG. 2, the proposed temporal-window-anchor-based and 2D-CNN backboned action recognition network is exemplified with further details. Here, the classification network can operate in the same manner as in in order to provide the confidence scores for each window anchor.

The model may use a plurality of temporal window anchors from the raw videos as input. These window anchors are in particular a series of windows of different length, the centers of which are all at the same time point. In practice, such a group of window anchors is typically set up for a certain number of time steps throughout the video. The use of anchors is originally from image-based object detection (cf. [16]) and was later adopted by the TAD methods when they were developed from the object detection methods (see [2], [3] and [4]). According to exemplary embodiments of the disclosure, this anchor strategy is transferred from the feature domain to the temporal domain. The latter can set the anchors closer in time than the former, which is limited to the temporal receptive field of the network.

Closer anchors allow the model to more accurately perceive the action limits. A similar method in the literature is the use of sliding windows defined by window length and overlap rate (cf. [7], [17], and [19]). However, in this way different image positions are covered by a different number of windows, making it more difficult to integrate information on a common basis. In contrast, this is possible in the window anchor-based approach according to exemplary embodiments of the disclosure.

According to embodiments of the disclosure, a regional confidence module (RCM) is used to form the temporal bounding box of the action instance and the label. This distinguishes embodiments of the disclosure from conventional solutions. The approach is based on the consideration that the performance of the network for predicting confidence scores is not only influenced by the length of the window anchors, but also by their location. If the feature is recognizable to the network, either positive or negative, all window anchors within the action/background duration will receive a similar score, meaning they have the same view of the region. However, if the feature of the input to the network is not so recognizable due to interference from the background or poor lighting of the camera, etc., the performance of the network fluctuates not only between the window anchors located at the same time point, but also along the time axis. Thus, it is proposed and according to exemplary embodiments of the disclosure that the evaluation of the output of the input region should be based not only on the confidence scores at a given time point, but on the overall confidence score of the entire candidate region. In this way, the model's performance may be improved and flickering during detection may be reduced.

In the following, the operation of the model is described in more detail with reference to FIG. 2.

First, the first images from an uncut video with a particular frame rate may be extracted as image data 201. Then, time points may be defined evenly along the time axis t of the image data 201 or the video, respectively, wherein the time point is designated with the number as tₘ (=1, 2, . . . , ). For each time point tₘ, a set of windows 202, 203, 204 of different length can then be generated, the centers of which are all aligned with the time point tₘ and referred to as window anchors. Assuming different lengths are provided, then there are x window anchors in the entire video. The window anchor at the time point tₘ with the length type of the number is referred to as W_{n,m} (n=1, 2, . . . , N, m=1, 2, . . . , M).

Each window anchor W_{n,m} can be processed with a sophisticated action recognition/classification module 230, e.g. from [14]. The window is first divided into a number of temporal segments 231, 232, 233 (see step 211). A frame (picture) 235, 236, 237 is randomly selected from each segment (see step 212) and fed into a 2D CNN-like network (also referred to as “backbone”) to extract features 241, 242, 243 (see step 213). Then, the features of all the images from different segments are concatenated for temporal integration (see step 214).

The concatenated/integrated feature 245 contains both spatial and temporal information and ultimately passes to the FC (fully connected) layer 221 as well as to a Softmax function 222 for the final prediction of the at least one class confidence score.

In FIG. 3, the principle of operation of the regional confidence module (RCM) is further exemplarily illustrated. S_{k,n,m} may be referred to as the score obtained from the window anchor W_{n,m} towards the class (=1.2, . . . ), wherein the number of action classes is referred to. A confidence point matrix S_{K×N×M} is obtained throughout the video. This confidence score matrix S_{K×N×M} may be passed to the regional confidence module, as further exemplified below using the sequence 300 of steps shown in FIG. 3:

First, the confidence scores are calculated as described above for each window anchor W_{n,m} towards the class, i.e. the action classes (p. 301). For each window anchor or for each candidate region, N confidence scores may be determined, wherein N may correspond to the number of classes used for classification. One of the classes may also be defined as a background class.

Then, the average values of all window anchors W_{n,m} located at the same time point S̅ₖ, m can then be calculated, in order to reduce predictive fluctuations due to different window types (see 302). A threshold value for the score may then be set to S̅_{k,m} along the time axis and the consecutive time points that lie above this threshold value can be grouped (p. 303). This serves to form the possible temporal regions of actions, i.e. candidate regions, that are referred to as

$${R}_{i} = \{ {S}_{k , n , p}^{( i )} \} ( p = 1 , 2 , … , {m}_{e}^{( i )} - {m}_{s}^{( i )} + 1 ; i = … , {N}_{r} ) . \qquad ( p . 304 )$$

Here Nr refers to the number of candidate regions generated throughout the video and

$${m}_{s}^{( i )} and {m}_{e}^{( i )}$$

refer to the start and end positions of the regions.

A series of successive time points were determined for each candidate region by the preceding procedure 300, at which the different window types match on average that an action (class) must have taken place. However, the performance of the different window types differs slightly from each other, and even with the same window type, the different temporal position also plays a role in the performance. Thus, the consensus between the window anchors and their stability along the time axis can be used to decide whether the candidate region can be characterized as a positive class or as a background. This may be done using the mean value and the deviation of the confidence scores. The module responsible for this may be referred to as the regional confidence module.

The average score across window types at the location may be referred to as

$${\overline{S}}_{k , p}^{( i )} .$$

The result is:

$${\overline{S}}_{k , p}^{( i )} = {\sum }_{n = 1}^{N} {\overline{S}}_{k , n , p}^{( i )}$$

For window anchors of the number, the difference between its score

$${S}_{k , n , p}^{( i )}$$

and the average score

$${\overline{S}}_{k , p}^{( i )}$$

may be referred to as

$${\tilde{S}}_{k , n , p}^{( i )}$$

$${\tilde{S}}_{k , n , p}^{( i )} = {S}_{k , n , p}^{( i )} - {\overline{S}}_{k , p}^{( i )}$$

According to step 315, the last two dimensions of

$${S}_{k , n , p}^{( i )}$$

can be smoothed to calculate the average score towards class k for all window types across the entire region

$${μ}_{k}^{( i )}$$

(it can also be determined by averaging

$${\overline{S}}_{k , p}^{( i )}$$

along the time axis). And similarly, the last two dimensions of

$${\tilde{S}}_{k , n , p}^{( i )}$$

can be flattened to calculate the corresponding deviation

$${σ}_{k}^{( i )}$$

Then, according to step 316, the ratio of the two can be used to define the regional confidence score(s), also referred to as regional confidence scores, of the candidate region Ri with respect to class k as

$${f}_{k}^{( i )} .$$

$${f}_{k}^{( i )} = \frac{{μ}_{k}^{( i )}}{{σ}_{k}^{( i )}}$$

With this regional confidence score, according to step 317, Softmax can be applied to

$${f}_{k}^{( i )}$$

in order to obtain the final label 318 of the region.

In order to determine the limits 314 of the region, it is known from practice that in most decreases almost uniformly cases, from the middle of the candidate region, the average score

$${\overline{S}}_{k , p}^{( i )}$$

decreases almost uniformly to a number close to zero upon as the limits of the ground truth are approached, so that that that small number may be set as a threshold value. The time points at which the average score drops to the left and right of this threshold value are the refined start and end times of the recognized region. According to step 311, the score fluctuations or differences for each window type relative to their average over the different window types are therefore calculated at each point in time. According to step 312, the regional deviation from these score fluctuations can then be determined. According to step 313, the time points at which the average score decreases towards the threshold value may be determined. A connection between 313 and 317 can further be seen in FIG. 3 to show that determining a start and end time for the action (see 314) requires an indication of the winning class, which can result from 317.

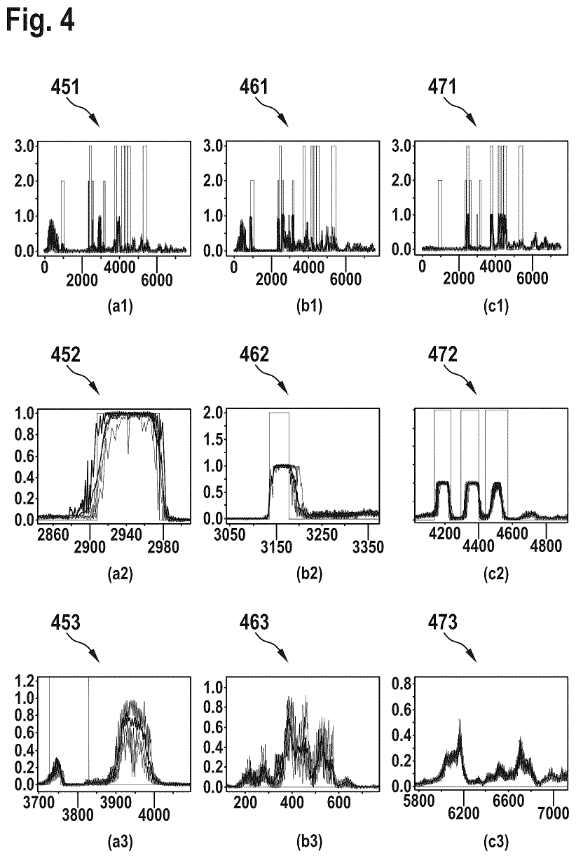

FIG. 4 shows the result of the proposed model for one of the driving scenario videos. Representations 451, 461 and 471 are the confidence scores for the entire video with respect to the three action classes. Illustrations 452, 462 and 472 are the enlarged illustrations of a TP (true positive) instance and illustrations 453, 463 and 473 are the enlarged figures of an FP (false positive) instance.

The above explanation of the embodiments describes the present disclosure solely within the scope of examples. Of course, individual features of the embodiments may be freely combined with one another, if technically feasible, without leaving the scope of the present disclosure.

### Overview of References:

[1] M. Yang, G. Chen, Y. Zheng, T. Lu and L. Wang. BasicTAD: an Astounding RGB-Only Baseline for Temporal Action Detection, arXiv, 2023.
[2] C. Wang, H. Cai, Y. Zou, Y. Xiong. RGB Stream Is Enough for Temporal Action Detection, arXiv, 2021.
[3] L. Yang, H. Peng, D. Zhang, J. Fu, J. Han. Revisiting Anchor Mechanisms for Temporal Action Localization, arXiv, 2020.
[4] T. Lin, X. Zhao, Z. Shou. Single Shot Temporal Action Detection, arXiv, 2017.
[5] D. Tran, J. Ray, Z. Shou, S. Chang, M. Paluri. ConvNet Architecture Search for Spatiotemporal Feature Learning, arXiv, 2017.
[6] T. Lin, X. Zhao, H. Su, C. Wang, M. Yang. BSN: Boundary Sensitive Network for Temporal Action Proposal Generation, arXiv, 2018.
[7] J. Gao, Z. Yang, C. Sun, K. Chen, R. Nevatia. TURN TAP: Temporal Unit Regression Network for Temporal Action Proposals, arXiv, 2017.
[9] Y. Zhao, Y. Xiong, L. Wang, Z. Wu, X. Tang, D. Lin. Temporal Action Detection with Structured Segment Networks, arXiv, 2019.
[10] A. Montes, A. Salvador, S. Pascual, X. Giro-i-Nieto Temporal Activity Detection in Untrimmed Videos with Recurrent Neural Networks, arXiv, 2017.
[11] S. Yeung, O. Russakovsky, N. Jin, M. Andriluka, G. Mori, F. Li, Every Moment Counts: Dense Detailed Labeling of Actions in Complex Videos, arXiv, 2017.
[12] J. Carreira, A. Zisserman. Quo vadis, action recognition? a new model and the kinetics dataset, arXiv, 2018.
[14] DE 10 2022 203 729 A1
[15] Z. Liu, L. Wang, W. Wu, C. Qian, T. Lu. TAM: Temporal Adaptive Module for Video Recognition, arXiv, 2020.
[16] W. Liu, D. Anguelov, D. Erhan, C. Szegedy, S. Reed, C. Fu, A. Berg. SSD: Single Shot MultiBox Detector, arXiv, 2016.
[17] Z. Shou, D. Wang, S. Chang Temporal Action Localization in Untrimmed Videos via Multi-stage CNNs, arXiv, 2016.
[18] D. Oneata, J. Verbeek and C. Schmid. Action and Event Recognition with Fisher Vectors on a Compact Feature Set, 2013 IEEE International Conference on Computer Vision, pp. 1817-1824, doi: 10.1109/ICCV.2013.228. Sydney, NSW, Australia, 2013.
[19] J. Gao, K. Chen, R. Nevatia. CTAP: Complementary Temporal Action Proposal Generation, arXiv, 2018.

What is claimed is:

1. A method for the temporal detection of actions, comprising:
providing image data, wherein the image data represents a temporal sequence of actions, wherein the image data results from sensory acquisition, and wherein a time axis is defined by the temporal sequence;
defining multiple time points along the time axis;
processing the provided image data by a plurality of windowings along the time axis, wherein a plurality of windows of different length with their respective window anchors are aligned at each of the defined time points in order to define a respective temporal area of the image data along the time axis, and wherein the window anchors are defined by a predefined position along the windows;
determining confidence scores for each of the window anchors, wherein for this purpose the displayed actions are classified in each case based on the processed image data in the time area defined in each case;
performing evaluations for the window anchors aligned at the same time point, wherein for this purpose an average calculation of the confidence scores determined for the window anchors aligned at the same time point is made;
providing one or more temporal candidate areas for the defined time points and based on the evaluations in each case as a candidate for detection of at least one of the actions;
determining one or more regional confidence scores for the respective candidate area, wherein for this purpose the determined confidence scores for those window anchors aligned at a time point in the respective candidate area are processed; and
performing the detection comprising classifying the at least one action in at least one of the candidate areas based on the regional confidence scores and determining a time allocation of the respective classified action.

2. The method according to claim 1, wherein aligning the windows comprises:
defining the window anchors of the windows as the centers of the windows, and
aligning the windows of different lengths that are to be aligned at the same time point by aligning their centers with the same time point.

3. The method according to claim 1, wherein performing the evaluations for the window anchors aligned at the same time point each comprises:
forming an average value of the determined confidence scores for the window anchors in order to reduce fluctuations due to different window lengths, and
comparing the average value formed with a predefined evaluation criterion to evaluate the window anchors.

4. The method according to claim 1, wherein providing the one or more candidate areas comprises:
determining those window anchors that have a sufficient evaluation, and defining the respective candidate area based as a time interval on successive time points along the time axis at which the window anchors are aligned with sufficient evaluation.

5. The method according to claim 1, wherein:
classifying the at least one action comprises an application of a machine learning model, and
the following steps are provided for determining the at least one confidence score:
dividing the respective window into multiple segments,
randomly selecting an image from each of the segments,
processing the respective selected image by the machine learning model in order to extract at least one feature,
concatenating the extracted features, and
determining the confidence score for the window anchor of the respective window based on the concatenated features.

6. The method according to claim 1, wherein the processing for determining the one or more regional confidence scores comprises at least one of the following:
an average calculation,
a smoothing, and/or
an evaluation of a deviation,
in each case or on the basis of the determined confidence scores for those window anchors that are aligned at a time point in the respective candidate area.

7. The method according to claim 1, wherein:
on the basis of the detection and the classification and/or time allocation, a vehicle action is detected in an environment of a vehicle for at least partially automated driving, and
the image data results from sensory acquisition of the environment during travel of the vehicle.

8. A computer program comprising instructions for causing a computer to carry out the method according to claim 1 when the computer program is executed by the computer.

9. A device for data processing, configured to carry out the method according to claim 1.

10. A computer-readable storage medium, comprising instructions which, when executed by a computer, cause it to carry out the steps of the method according to claim 1.

11. The method according to claim 1, wherein the time allocation includes a start and end time of the respective classified action.

12. The method according to claim 3, wherein the predefined evaluation criterion includes a threshold value.

13. The method according to claim 5, wherein the machine learning model is a two-dimensional CNN having a head.
